(19) United States
(12) Patent Application Publication
(10) Pub. No.: US 2005/0103890 A1
(43) Pub. Date: May 19, 2005

(54) Shower head for selectively adding liquid soap to shower water

(76) Inventors: Bernard Doyle, Montclair, NJ (US); Sallie Maynard, Montclair, NJ (US)

Correspondence Address: Bernard Doyle, Apt #2, 4 Claremont Place, Montclair, NJ, 07042, US

(21) Appl. No.: 10/716,636

(22) Filed: Nov. 19, 2003

(51) Int. Cl. B05B 7/26

(52) U.S. Cl. 239/314

(57) ABSTRACT

A shower head for selectively adding liquid soap to shower water. A partition contained in the nozzle defines first and second chambers contained in the nozzle. A reservoir contained in the nozzle holds the liquid soap therein and fluidly communicates with the second chamber. An apparatus contained in the nozzle selectively directs water from a water source into either the first chamber where it exists the nozzle as the shower water or into the second chamber where by creating a negative pressure due to its flow draws down the liquid soap from the reservoir to mix therewith and exit the nozzle as soapy shower water.

### BACKGROUND OF THE INVENTION

1. Field of the Invention

The present invention relates to a shower head. More particularly, the present invention relates to a shower head for selectively adding liquid soap to shower water.

2. Description of the Prior Art

Numerous innovations for a shower head for selectively adding liquid soap to shower water have been provided in the prior art that will be described. Even though these innovations may be suitable for the specific individual purposes to which they address, however, they differ from the present invention.

FOR EXAMPLE, U.S. Pat. No. 3,764,074 to James teaches a shower head and liquid agent dispensing attachment that includes valving apparatus which interconnects a source of pressurized liquid and spray dispenser having single control positionable from one extreme, at which just the pressurized liquid is provided, to another extreme at which a mixture of the first liquid and liquid agent are provided, the liquid agent container also being interconnected with the valving apparatus.

ANOTHER EXAMPLE, U.S. Pat. No. 4,121,773 to Headen teaches a shower head dispenser for bath oil and the like which includes a body member with an axial bore adapted for insertion between a shower line and a shower head. The body member has two longitudinally spaced apertures in its side wall which communicate between the bore and a detachable oil container. A plug is rotatably mounted in the bore of the body. It has an axial venturi bore therethrough, and a pair of transverse bores, one of which intercepts the axial bore at the venturi throat, and the other of which intercepts the axial bore upstream of the throat. The transverse bores of the plug are registrable with the apertures of the body upon rotation of the plug. When water passes through the venturi bore of the plug with the transverse bores aligned with the apertures, the greater pressure at the upstream bore and aperture forces oil out of the container through the downstream bore and aperture into the venturi throat, where it mixes with water enroute to the shower head.

STILL ANOTHER EXAMPLE, U.S. Pat. No. 4,193,520 to Duffield teaches a device for adding liquid soap to shower water. Liquid soap is drawn through a tube member by harnessing the negative pressure in a sleeve member, situated within a water source leading to a shower nozzle, relative to the atmosphere. Means for controlling the volume of soap flowing through a tube member adjusts the amount of soap going through the shower head.

YET ANOTHER EXAMPLE, U.S. Pat. No. 4,651,930 to Magaha, Jr. teaches a shower head attachment that has a liquid detergent reservoir and facilitates a “soap,” “rinse,” and “off” cycle. The attachment has a body provided with a rotary valve having a transverse port. The port is alined, selectively, with a first or second longitudinal inclined passageway formed in the body forwardly of the valve. A third passageway of critical internal diameter communicates the first passageway with an opening formed in a depending neck on the body and acts as an aspirating passageway. A sleeve is secured within the opening and carries a depending feed tube. The feed tube extends into a reservoir or bottle of liquid detergent that is removably mounted on the depending neck of the body, externally of the sleeve. The sleeve has a valve seat above the feed tube, and a ball check valve is seated on the valve seat. The valve carries an external handle; and the ends of the handle carry depending cables, the ends of which are provided with respective tabs. A pin on the body is received in an arcuate slot in the handle to limit the rotary movement of the handle and valve. The liquid detergent is biodegradable and cooperates with the aspirating passageway to prevent clogging. It is critical that the liquid detergent has the proper viscosity relative to the internal diameter of the aspirating passageway so that the detergent is aspirated out of the bottle and into the shower head attachment at the desired rate.

STILL YET ANOTHER EXAMPLE, U.S. Pat. No. 5,071,070 to Hardy teaches an apparatus to selectively introduce a fluid from one of a plurality of containers into a stream of water flowing through a shower head. The apparatus comprises a housing, a main water passageway therethrough, a plurality of bottles containing fluid to be fed therefrom, supplemental passageways coupling the bottles and the main water passageway whereby fluid from the container may flow to the main passageway by venturi forces created by flowing water, a valve mechanism means movable between open and closed positions by the venturi forces to allow or preclude the feeding of fluid to the flow of water, and user controlled means to selectively allow the valve mechanism to be coupled with the venturi force. Also disclosed is the method for selectively introducing a fluid from a container into a stream of water flowing through a shower head by venturi forces of the flowing water.

YET STILL ANOTHER EXAMPLE, U.S. Pat. No. 5,356,076 to Bishop teaches a soap dispenser for use with liquid soaps, primarily in showers, that has a unique multi-position valve, and separate mixing and air entraining controls. Liquid soap stored in a reservoir is drawn into a flowing water stream by siphonic action. The amount of soap/air mixture is regulated by a mixture valve. Air in controllable proportions is added by an air entrainment valve. The proportion of air with respect to the soap is adjustable. Simultaneous control of the amount of soap/air mixed with the flowing water stream is controlled by a unique mixture valve geometry.

It is apparent that numerous innovations for a shower head for selectively adding liquid soap to shower water have been provided in the prior art that are adapted to be used. Furthermore, even though these innovations may be suitable for the specific individual purposes to which they address, however, they would not be suitable for the purposes of the present invention as heretofore described.

### SUMMARY OF THE INVENTION

ACCORDINGLY, AN OBJECT of the present invention is to provide a shower head for selectively adding liquid soap to shower water that avoids the disadvantages of the prior art.

ANOTHER OBJECT of the present invention is to provide a shower head for selectively adding liquid soap to shower water that is simple to use.

BRIEFLY STATED, STILL ANOTHER OBJECT of the present invention is to provide a shower head for selectively adding liquid soap to shower water. A partition contained in the nozzle defines first and second chambers contained in the nozzle. A reservoir contained in the nozzle holds the liquid soap therein and fluidly communicates with the second chamber. An apparatus contained in the nozzle selectively directs water from a water source into either the first chamber where it exists the nozzle as the shower water or into the second chamber where by creating a negative pressure due to its flow draws down the liquid soap from the reservoir to mix therewith and exit the nozzle as soapy shower water.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWINGS

The figures of the drawings are briefly described as follows:

FIG. 1 is a diagrammatic perspective view of the shower head of the present invention;

FIG. 2 is a diagrammatic cross sectional view taken along LINE 2-2 in FIG. 1 of the shower head of the present invention in the shower water only mode; and

FIG. 3 is a diagrammatic cross sectional view taken along LINE 3-3 in FIG. 1 of the shower head of the present invention in the combined shower water and liquid soap mode.

### LIST OF REFERENCE NUMERALS UTILIZED IN THE DRAWINGS

10 shower head of present invention for selectively adding liquid soap 12 to shower water 14
12 liquid soap
14 shower water
16 nozzle
18 reservoir contained in nozzle 16 for holding liquid soap 12
20 partition contained in nozzle 16
22 apparatus contained in nozzle 16 for selectively directing water 28 from water source 30 into either first chamber 24 contained in nozzle 18 where it exists nozzle 16 as shower water 14 or into second chamber 26 contained in nozzle 16 where by creating negative pressure due to its flow draws down liquid soap 12 from reservoir 18 contained in nozzle 16 to mix therewith and exit nozzle 16 as soapy shower water 32
24 first chamber contained in nozzle 16
26 second chamber contained in nozzle 16
28 water from water source 30
30 water source
32 soapy shower water
34 forwardmost wall of nozzle 16
36 uppermost wall of nozzle 16
38 rearwardmost wall of nozzle 16
40 outlet of nozzle 16
42 floor defining reservoir 18 contained in nozzle 16
43 plug of reservoir 18 contained in nozzle 16 for allowing reservoir 18 contained in nozzle 16 to be filled with liquid soap 12
44 perforations in floor 42 defining reservoir 18 contained in nozzle 16 for allowing liquid soap 12 to leave reservoir 18 contained in nozzle 16 and enter second chamber 26 contained in nozzle 16
46 soapy shower water
48 conduit contained in nozzle 16
50 terminal end of floor 42 defining reservoir 18 contained in nozzle 16
52 door of apparatus 22
54 pivot pin of door 52 of apparatus 22
56 terminal end of pivot pin 54 of apparatus 22
58 knob of apparatus 22
60 handle

### DETAILED DESCRIPTION OF THE INVENTION

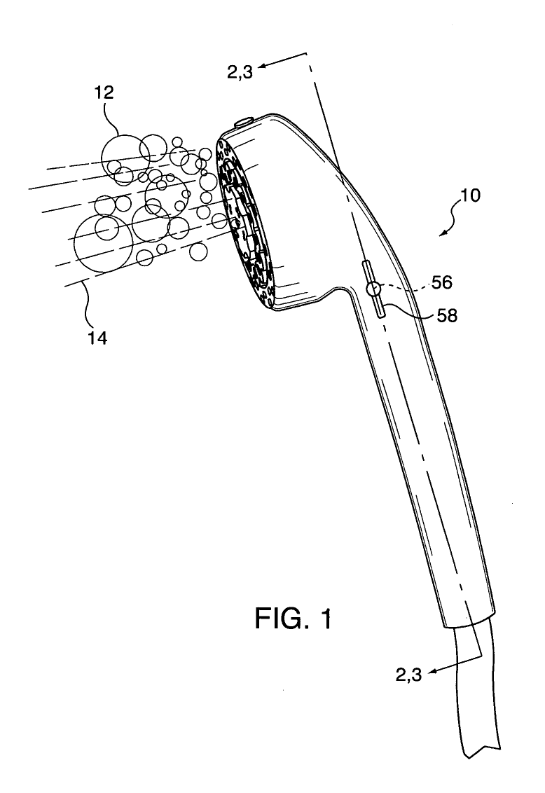

Referring now to the figures, in which like numerals indicate like parts, and particularly to FIG. 1, which is a diagrammatic perspective view of the shower head of the present invention, the shower head of the present invention is shown generally at 10 for selectively adding liquid soap 12 to shower water 14.

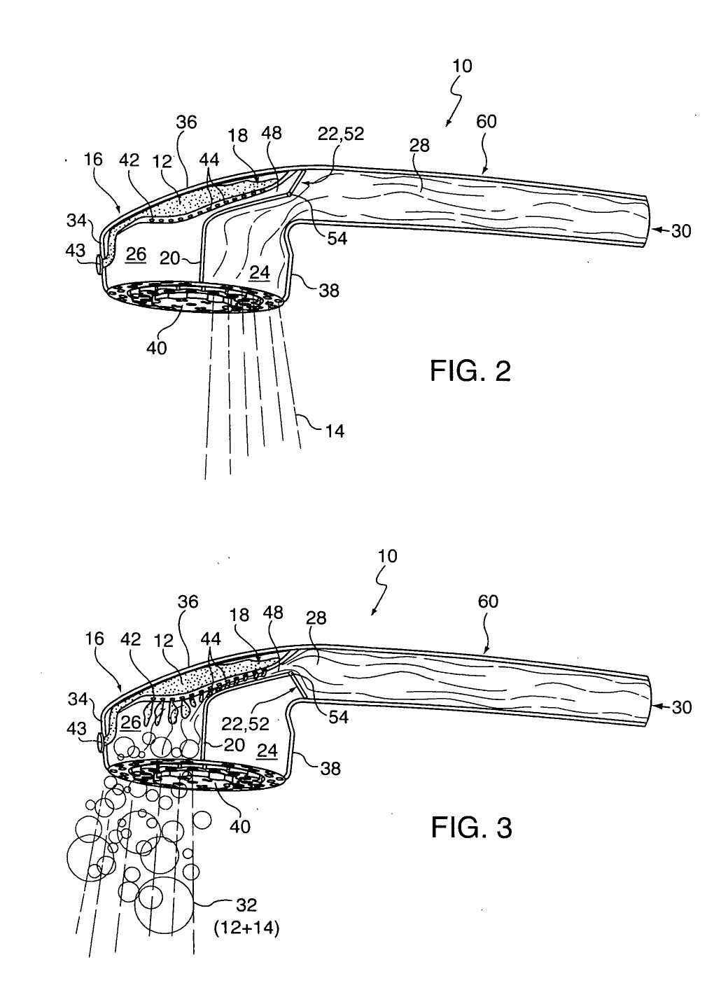

The configuration of the shower head 10 can best be seen in FIG. 2 and in FIG. 3, which are, respectively, a diagrammatic cross sectional view taken along LINE 2-2 in FIG. 1 of the shower head of the present invention in the shower water only mode, and a diagrammatic cross sectional view taken along LINE 3-3 in FIG. 1 of the shower head of the present invention in the combined shower water and liquid soap mode, and as such, will be discussed with reference thereto.

The shower head 10 comprises a nozzle 16, a reservoir 18, a partition 20, and an apparatus 22. The partition 20 is contained in the nozzle 16 and defines a first chamber 24 and a second chamber 26 in the nozzle 16. The reservoir 18 is contained in the nozzle 16, is for holding the liquid soap 12 therein, and fluidly communicates with the second chamber 26 contained in the nozzle 16. The apparatus 20 is contained in the nozzle 16 and is for selectively directing water 28 from a water source 30 into either the first chamber 24 contained in the nozzle 18 where it exists the nozzle 16 as the shower water 14 (FIG. 2) or into the second chamber 26 contained in the nozzle 16 where by creating negative pressure due to its flow draws down the liquid soap 12 from the reservoir 18 contained in the nozzle 16 to mix therewith and exit the nozzle 16 as soapy shower water 32 (FIG. 3).

The nozzle 16 has a forwardmost wall 34, an uppermost wall 36, a rearwardmost wall 38, and an outlet 40.

The reservoir 18 contained in the nozzle 16 is defined by a floor 42. The floor 42 defining the reservoir 18 contained in the nozzle 16 extends rearwardly and upwardly from the forwardmost wall 34 of the nozzle 16 to the uppermost wall 36 of the nozzle 16.

The reservoir 18 contained in the nozzle 16 has a plug 43. The plug 43 of the reservoir 18 contained in the nozzle 16 is disposed at the forwardmost wall 34 of the nozzle 16, and when removed is for allowing the reservoir 18 contained in the nozzle 16 to be filled with the liquid soap 12.

The floor 42 defining the reservoir 18 contained in the nozzle 16 has perforations 44. The perforations 44 in the floor 42 defining the reservoir 18 contained in the nozzle 16 allow the reservoir 18 contained in the nozzle 16 to fluidly communicate with the second chamber 26 contained in the nozzle 16 and for allowing the liquid soap 12 to leave the reservoir 18 contained in the nozzle 16, enter the second chamber 26 contained in the nozzle 16, mix with the water 28 of the water source 30, and exit the nozzle 16 as the soapy shower water 32 when the water 28 of the water source 30 is directed by the apparatus 22 into the second chamber 26 contained in the nozzle 16 and creates the negative pressure due to its flow that draws down the liquid soap 12 from the reservoir 18 contained in the nozzle 16 into the second chamber 26 contained in the nozzle 16.

The partition 20 contained in the nozzle 16 extends upwardly from engagement with the outlet 40 of the nozzle 16 to below the floor 42 defining the reservoir 18 contained in the nozzle 16 so as to form a conduit 48 therebetween, and then extends rearwardly therefrom still below the floor 42 defining the reservoir 18 contained in the nozzle 16 to between the uppermost wall 36 of the nozzle 16 and the rearwardmost wall 38 of the nozzle 16 where it terminates in a terminal end 50.

The apparatus 22 comprises a door 52. The door 52 of the apparatus 22 is pivotally attached by a pivot pin 54 to the terminal end 50 of the partition 20 contained in the nozzle 16.

The door 52 of the apparatus 22 sweeps from a first position of engagement with the uppermost wall 36 of the nozzle 16 where it closes the conduit 48 contained in the nozzle 16 preventing the water 28 from the water source 30 from entering the second chamber 26 contained in the nozzle 16 and mixing with the liquid soap 12 while simultaneously opening communication of the water 28 from the water source 30 with the first chamber 24 contained in the nozzle 16 so at allow only the shower water 14 to exit the outlet 40 of the nozzle 16 (FIG. 2), to a second position of engagement with the rearwardmost wall 38 of the nozzle 16 where it closes communication of the water 28 from the water source 30 with the first chamber 24 contained in the nozzle 16 while simultaneously opening the conduit 48 contained in the nozzle 16 allowing the water 28 from the water source 30 to enter the second chamber 26 contained in the nozzle 16 and mix with the liquid soap 12 by creating the negative pressure that draws down the liquid soap 12 from the reservoir 18 contained in the nozzle 16 thereinto so at allow only the soapy shower water 32 to exit the outlet 40 of the nozzle 16 (FIG. 3).

The pivot pin 54 of the apparatus 22 extends through the nozzle 16 to a terminal end 56 (FIG. 1).

The apparatus 22 further comprises a knob 58 (FIG. 1). The knob 58 of the apparatus 22 engages, and rotates with, the terminal end 56 of the pivot pin 54 of the apparatus 22 so as to selectively move the door 52 of the apparatus 22 between its first and second positions.

The shower head 10 further comprises a handle 60. The handle 60 extends from, and is in fluid communication with, the nozzle 16.

It will be understood that each of the elements described above, or two or more together, may also find a useful application in other types of constructions differing from the types described above.

While the invention has been illustrated and described as embodied in a shower head for selectively adding liquid soap to shower water, however, it is not limited to the details shown, since it will be understood that various omissions, modifications, substitutions and changes in the forms and details of the assembly illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

1. A shower head for selectively adding liquid soap to shower water, comprising:
a) a nozzle;
b) a reservoir;
c) a partition; and
d) an apparatus;
wherein said reservoir is contained in said nozzle;
wherein said reservoir contained in said nozzle is for holding the liquid soap therein;
wherein said partition is contained in the nozzle;
wherein said partition contained in said nozzle defines a first chamber contained in the nozzle;
wherein said partition contained in said nozzle defines a second chamber contained in the nozzle;
wherein said reservoir contained in said nozzle fluidly communicates with said second chamber contained in said nozzle;
wherein said apparatus is contained in said nozzle; and
wherein said apparatus contained in said nozzle is for selectively directing water from a water source into either said first chamber contained in said nozzle where it exists said nozzle as the shower water or into said second chamber contained in said nozzle where by creating a negative pressure due to its flow draws down the liquid soap from said reservoir contained in said nozzle to mix therewith and exit said nozzle as soapy shower water.

2. The shower head as defined in claim 1, wherein said nozzle has a forwardmost wall;
wherein said nozzle has an uppermost wall;
wherein said nozzle has a rearwardmost wall; and
wherein said nozzle has an outlet.

3. The shower head as defined in claim 2, wherein said reservoir contained in said nozzle is defined by a floor.

4. The shower head as defined in claim 3, wherein said floor defining said reservoir contained in said nozzle extends rearwardly and upwardly from said forwardmost wall of said nozzle to said uppermost wall of said nozzle.

5. The shower head as defined in claim 1, wherein said reservoir contained in said nozzle has a plug; and
wherein said plug of said reservoir contained in said nozzle is for allowing said reservoir contained in said nozzle to be filled with the liquid soap when removed.

6. The shower head as defined in claim 5, wherein said plug of said reservoir contained in said nozzle is disposed at said forwardmost wall of said nozzle.

7. The shower head as defined in claim 3, wherein said floor defining said reservoir contained in said nozzle has perforations;
wherein said perforations in said floor defining said reservoir contained in said nozzle allow said reservoir contained in said nozzle to fluidly communicate with said second chamber contained in said nozzle; and
wherein said perforations in said floor defining said reservoir contained in said nozzle is for allowing the liquid soap to leave said reservoir contained in said nozzle, enter said second chamber contained in said nozzle, mix with the water from the water source, and exit said nozzle as soapy shower water when the water from the water source is directed by said apparatus into said second chamber contained in said nozzle and creates the negative pressure due to its flow that draws down the liquid soap from said reservoir contained in said nozzle into said second chamber contained in said nozzle.

8. The shower head as defined in claim 3, wherein said partition contained in said nozzle extends upwardly from engagement with said outlet of said nozzle to below said floor defining said reservoir contained in said nozzle so as to form a conduit therebetween, and then extends rearwardly therefrom still below said floor defining said reservoir contained in said nozzle to between said uppermost wall of said nozzle and said rearwardmost wall of said nozzle where it terminates in a terminal end.

9. The shower head as defined in claim 8, wherein said apparatus comprises a door;
wherein said door of said apparatus is pivotally attached to said terminal end of said partition contained in said nozzle.

10. The shower head as defined in claim 9, wherein said door of said apparatus is pivotally attached by a pivot pin to said terminal end of said partition contained in said nozzle.

11. The shower head as defined in claim 9, wherein said door of said apparatus sweeps from a first position of engagement with said uppermost wall of said nozzle where it closes said conduit contained in said nozzle preventing the water from the water source from entering said second chamber contained in said nozzle and mixing with the liquid soap while simultaneously opening communication of the water from the water source with said first chamber contained in said nozzle so at allow only the shower water to exit said outlet of said nozzle, to a second position of engagement with said rearwardmost wall of said nozzle where it closes communication of the water from the water source with said first chamber contained in said nozzle while simultaneously opening said conduit contained in said nozzle allowing the water from the water source to enter said second chamber contained in said nozzle and mix with the liquid soap by creating the negative pressure that draws down the liquid soap from said reservoir contained in said nozzle thereinto so at allow only the soapy shower water to exit said outlet of said nozzle.

12. The shower head as defined in claim 10, wherein said pivot pin of said apparatus extends through said nozzle to a terminal end.

13. The shower head as defined in claim 12, wherein said apparatus comprises
a knob; and
wherein said knob of said apparatus engages, and rotates with, said terminal end of said pivot pin of said apparatus so as to selectively move said door of said apparatus between its first and second positions.

14. The shower head as defined in claim 1; further comprising a handle;
wherein said handle extends from said nozzle; and
wherein said handle is in fluid communication with said nozzle.
